(19) United States
(12) Patent Application Publication
(10) Pub. No.: US 2024/0344560 A1
(43) Pub. Date: Oct. 17, 2024

(54) Electric Motor Providing Bearing-Force Unloading

(71) Applicant: Wisconsin Alumni Research Foundation, Madison, WI (US)

(72) Inventors: Eric Severson, Middleton, WI (US); Nathan Petersen, Madison, WI (US)

(21) Appl. No.: 18/300,531

(22) Filed: Apr. 14, 2023

(51) Int. Cl. F16C 33/10; H02K 7/09

(52) U.S. Cl. CPC F16C 33/1005; H02K 7/09; F16C 2380/26

(57) ABSTRACT

The windings of an electric motor are used to reduce the loading of noncontact bearings through the application of an offsetting radial force. For aerodynamic gas bearings, this force may be converted to a torque force after sustaining levitation speeds have been obtained.

### STATEMENT REGARDING FEDERALLY SPONSORED RESEARCH OR DEVELOPMENT

### CROSS REFERENCE TO RELATED APPLICATION

### BACKGROUND OF THE INVENTION

The present invention relates to electric motors and, in particular, to an electric motor operated to reduce bearing load forces.

Common electric motors provide for a stationary stator surrounding a rotor mounted on a shaft for rotation with respect to the rotor. In order to reduce rotational friction of the shaft, the rotor is typically supported on bearings, for example, ball or roller bearings which reduce sliding friction. Bearings of this type, nevertheless, require contacting surfaces and thus present problems associated with the management of lubricant, surface erosion, and the generation of particulates, as well as non-negligible friction.

The above problems can be largely avoided through the use of non-contact bearings, for example, gas bearings or magnetic bearings in which the rotating and nonrotating surfaces of the bearing are separated by a thin film of air or magnetic force, respectively. Active non-contact magnetic bearings use electronic sensors and drive circuitry to control electromagnetic coils, dynamically adjusting the magnetic levitation and, for this reason, are relatively expensive. Active gas bearings (aerostatic) employ an external source of pressurized source of gas which also increases their cost of implementation.

A lower-cost alternative to the above active contactless bearings can be found in dynamic or “aerodynamic” gas bearings where a suspending gas film is pressurized by the relative velocity between the moving and stationary surfaces of the bearing. In so-called “foil bearings” or compliant gas bearings, pressurized air is generated by a “bump” foil. In other designs, the pressurized air is generated by a set of slots. Aerodynamic gas bearings require no external source of a pressurized gas, greatly simplifying their use.

One drawback to aerodynamic gas bearings is that they experience sliding friction between the inner and outer bearing race as the motor starts, but before the relative speed between the inner and outer bearing race is sufficient to generate a pressurized levitating film of air. For this reason, such bearings are generally considered impractical for larger electric motors, for example, over 200-500 kW, where such sliding friction creates excessive wear at the elevated rotor weights.

An alternative approach to the problems associated with bearings is the so-called “bearingless motor” where the motor coils are energized both to apply torque to the rotor and also to levitate the rotor against the force of gravity. Such bearingless motors, however, typically require ancillary bearings to control axial movement or to support the rotor against cross-axis torques (about an axis perpendicular to the axis rotation), usually using relatively expensive magnetic bearings. Further, levitation of the rotor by magnetic fields, as is done with bearingless motors, requires precise rotor displacement sensors, a sophisticated control system capable of high-speed response, and substantial power output not only to levitate the rotor but also to stabilize it against torques developed during use. These requirements greatly increase the cost of a bearingless motor design.

### SUMMARY OF THE INVENTION

The present invention uses a motor drive to apply a levitation component to the motor rotor independent of the rotor displacement eliminating the need for sophisticated displacement sensing yet sufficient to provide an unloading of force on the bearings. This unloading can protect dynamic gas bearings during their vulnerable startup time and can be used to reduce the cost of other types of noncontact bearings by reducing their maximum load. To the extent that the unloading force need not be sufficient to levitate the rotor, the invention can work with a larger range of motor sizes and motor drives having limited power output.

In one embodiment, the invention provides an electric motor apparatus including an electric motor having a stator and a rotor rotatable on a shaft about an axis with respect to the stator, the electric motor including a winding set producing a magnetic field applying a force between the rotor and stator. At least one bearing supports the shaft for rotation and a motor drive controls the winding set of the electric motor to apply a radial force to the rotor independent of torque force and independent of a contemporaneous measure radial rotor displacement with respect to the stator.

It is thus a feature of at least one embodiment of the invention to provide a simple and low-cost method of reducing bearing load without the need for sophisticated levitation systems.

The predetermined upward force may be vertical.

It is thus a feature of at least one embodiment of the invention to allow reduction in a principal bearing load caused by the weight of the rotor.

The predetermined upward force may be substantially constant for a full revolution of the rotor.

It is thus a feature of at least one embodiment of the invention to provide a system that can be implemented in low-speed control systems.

The bearings may be gas bearings, and the motor drive may apply the predetermined upward force to the rotor during a first interval defined by the rotational speed of the rotor being below a predetermined speed threshold and remove the predetermined upward force to the rotor during a second interval defined by the rotor speed of the rotor above the predetermined speed threshold.

It is thus a feature of at least one embodiment of the invention to greatly prolong the life of compliant gas bearings by reducing frictional forces during bearing startup. It is another feature of at least one embodiment of the invention to produce improved energy efficiencies in the motor by diverting levitation power into torsional power once the gas bearings are fully operational.

These particular objects and advantages may apply to only some embodiments falling within the claims and thus do not define the scope of the invention.

### BRIEF DESCRIPTION OF THE DRAWINGS

FIG. 1 is a simplified side elevational view of an electric motor in partial cross section and suitable for use with the present invention communicating with a motor drive;

FIG. 2 is a plot of absolute levitation and torque forces produced by the motor drive of FIG. 1 over time; and

FIG. 3 is a plot of the vertical force component of the levitation component and torque forces of FIG. 2 as a function of waveform angle; and

### DETAILED DESCRIPTION OF THE PREFERRED EMBODIMENT

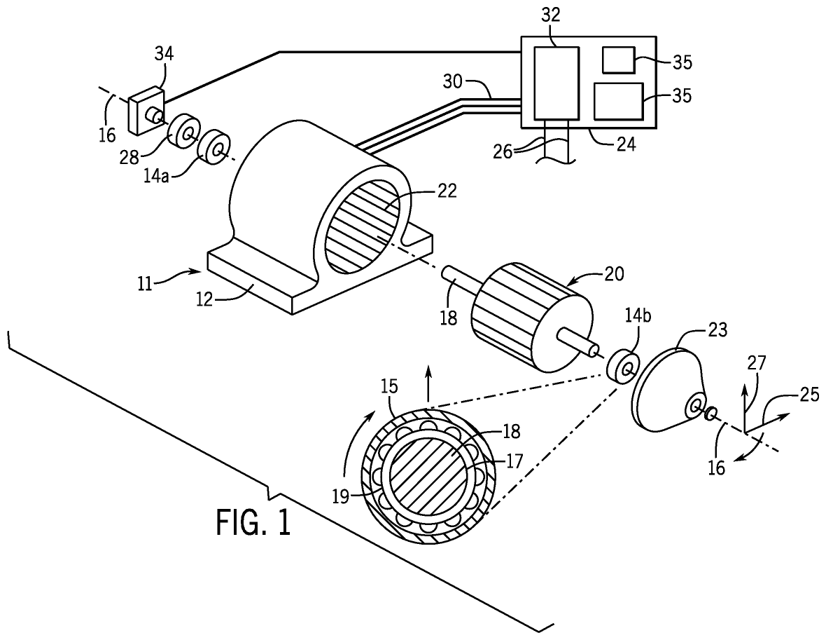

Referring now to FIG. 1, an electric motor system 10 may provide an electric motor 11 having a housing 12, for example, fixed to a stationary surface. The housing may support an outer race 15 of first and second contactless rotational bearings 14a and 14b aligned in opposition along an axis 16. As so positioned, the inner races 17 of the rotational bearings 14a and 14b may support a shaft 18 extending along the axis 16 for rotation thereabout.

The shaft 18 in turn may support a rotor 20 for concentric rotation within a stator 22 fixed with respect to the housing 12. The shaft 18 may also provide power to a load such as a compressor turbine 23 to drive the turbine 23 at high speeds. The bearings 14 may work in conjunction with a thrust bearing 28 designed to resist axial shaft forces which may be a conventional or contactless bearing.

The rotational bearings 14a and 14b in one embodiment may be magnetic bearings supporting the inner race 17 and thus the shaft 18 by means of magnetic forces between the inner race 17 and the outer race 15. In one important application the magnetic bearings in combination are insufficient in capacity to support the weight of the rotor 20 and shaft 18 in magnetic levitation. Alternatively, the rotational bearings 14a and 14b may be gas or air bearings supporting the inner race 17 and thus shaft 18 on a film of pressurized gas between the inner race 17 and outer race 15. In one embodiment the gas bearings may be so-called foil bearings where the inner race is supported on a compliant spring-loaded foil 19 (typically a bump foil and a cylindrical foil combination) generating a pressurized film of air.

Generally, the motor 11 may be a variety of different designs including being a synchronous motor, for example, having permanent magnets on the rotor 20 or inductive designs in which the rotor 20 provides inductively coupled windings. At least one or both of the rotor 20 and stator 22 may provide for electromagnetic coils that may be controlled by a motor drive 24 to generate a rotating magnetic field that may impart a torque component force 25 to rotate the rotor 20 about the axis 16. Importantly, the motor drive 24 may also be adapted to apply a levitation component force 27 to the rotor 20 along a nonrotating vector oriented in opposition to the force of gravity and serving to offset the weight of the rotor 20. Both the torque component force 25 and the levitation component force 27 may be generated by the same windings (combined windings), or separate windings may be used to provide the torque component force 25 and the levitation component force 27. In both cases these forces are applied directly between the rotor 20 and stator 22.

Production of the torque component force 25 and levitation component force 27 by the motor drive 24 may make use of techniques known for use in bearingless motors but modified by the elimination of a control loop changing the levitation component force 27 according to a major rotor displacement normally required to maintain a levitation state. These techniques include those described in described in J. Chen, J. Zhu and E. L. Severson, “Review of Bearingless Motor Technology for Significant Power Applications,” in IEEE Transactions on Industry Applications, March-April 2020, doi: 10.1109/TIA.2019.2963381 and J. Chen, J. Zhu and E. L. Severson, “Review of Bearingless Motor Technology for Significant Power Applications,” in IEEE Transactions on Industry Applications, March-April 2020, doi: 10.1109/TIA.2019.2963381, hereby incorporated by reference. The generation of levitation component forces 27 should be distinguished from levitation in that the latter requires accurate balancing of the levitation component forces 27 with the gravitational forces on the rotor 20 (and attached structure) not required in the present invention.

The motor drive 24 may receive electrical line power 26 and provide a synthesized voltage output waveform 30, for example, using a conventional DC bus and bridge circuit 32 under control of control logic 35, the latter implemented with discrete circuitry or a computer processor and software in the stored memory. An optional rotor position encoder or tachometer 34 may be attached to the shaft 18 to provide a signal to the motor drive 24 for generating the torque component force 25 and levitation component force 27 and for switching the latter force as will be discussed below. Alternatively, similar information may be derived by monitoring saliency or the like reflected in the current and voltage of the output waveform 30.

In a combined winding motor, the torque component force 25 and levitation component force 27 may be produced as described in U.S. provisional application 63/365,092 filed May 20, 2022, and assigned to the assignee of the present application hereby incorporated by reference.

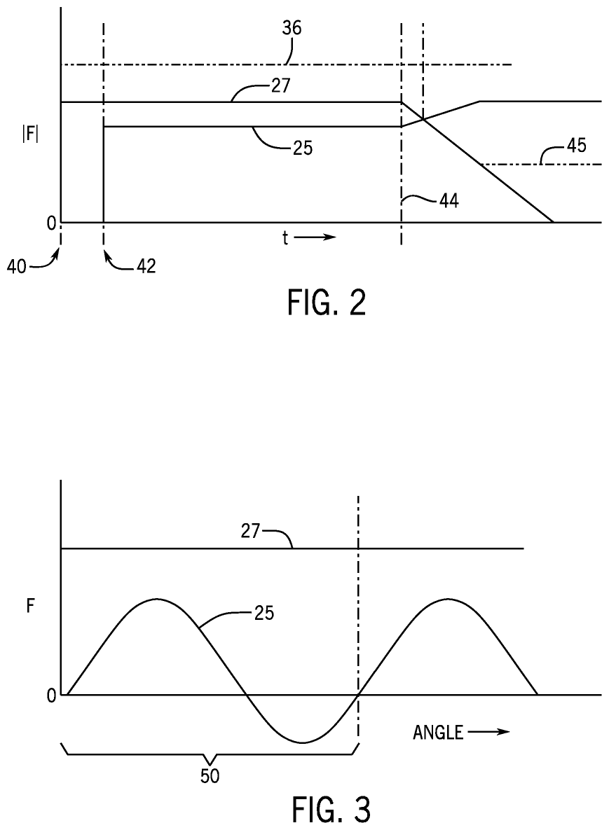

Referring now to FIG. 2, the motor controller 24 may operate to generate the levitation component force 27 at a prestartup time 40 prior to the application of the torque component force 25 to offload force from the bearings 14 prior to motion of the shaft 18. Generally, the levitation component force 27 will be less than that of a force 36 necessary to levitate the rotor 20. This ensures stability of the rotor 20 and minimizes energy use while greatly reducing the force on the bearings 14 and subsequent frictional wear during startup. For example, the levitation component force 27 may be set to less than 95% of the force 36 or less than 90% of this force 36.

Shortly thereafter, at a startup time 42 delayed to accommodate the necessary energization of the windings for levitation component force 27 and typically being less than five seconds, the torque component force 25 may be applied by the motor controller 24 to start rotation of the rotor 20. The motor speed increases until it reaches a sufficient RPM at a switchover time 44 and at which time the bearings 14 have developed a sufficient air film to suspend the rotor 20 without contact and without the levitation component force 27. The switchover time 44, for example, may be determined by tachometer 34.

After the switchover time 44, the levitation component force 27 may be reduced to zero allowing the full weight of the rotor and shaft 18 to be supported on the bearings 14 without sliding friction. At this time the energy used for the levitation component force 27 may be used all or in part to boost the torque component force 25.

Optionally, at switchover time 44, the levitation component force 27 may be reduced to a sustaining level 45 but not to zero. This is useful, for example, when using magnetic bearings or gas bearings that are undersized to save weight or cost. In this case, the motor control 24 controls the motor windings to preserve a levitation component force 27 but at reduced power. In one example, the sustaining level of the levitation component force 27 may be less than 50% of the force 36 caused by the weight of the rotor 20 shaft 18 and any associated components. The bearings 14 support the remaining force of gravity and provide stability against torques that are off axis 16.

While the above description has focused on offsetting a static load of the rotor (and associated shaft, bearing races, and loads) under the force of gravity, it will be appreciated that other static loads may also be addressed in this manner, for example, as caused by the airflow around the turbine 23 (shown in FIG. 1) that may impart a lateral static load to the rotor.

Referring now to FIG. 3, generally the levitation component force 27 will be nonzero and substantially constant for multiple rotational cycles 50 of the winding waveforms and rotations of the rotor 20 during which the direction of the torque component force 25 (shown here projected to a vertical axis) may vary substantially in magnitude and direction.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context

The term “substantially” is intended to mean equal to a degree necessary to realize the benefits associated with equivalence and in some cases may be quantitatively bounded by plus or minus 10%.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. An electric motor apparatus comprising:
an electric motor having a stator and a rotor rotatable on a shaft about an axis with respect to the stator, the electric motor including a winding set producing a magnetic field applying a force between the rotor and stator;
at least one bearing supporting the shaft for rotation; and
a motor drive controlling the winding set of the electric motor to apply a radial force to the rotor independent of torque force and independent of a contemporaneous measurement of radial rotor displacement with respect to the stator.

2. The electric motor apparatus of claim 1 wherein the predetermined upward force is vertical.

3. The electric motor apparatus of claim 1 wherein the predetermined upward force is substantially constant for a full revolution of the rotor.

4. The electric motor apparatus of claim 1 wherein the at least one bearing is a gas bearing and the motor drive applies the predetermined upward force to the rotor during a first interval determined with respect to a rotational speed of the rotor being below a predetermined speed threshold required to establish a pressurized gas layer for levitation and removes the predetermined upward force to the rotor during a second interval determined with respect to the rotor speed of the rotor being above the predetermined speed threshold.

5. The electric motor apparatus of claim 4 wherein the at least one bearing is a gas bearing and the predetermined speed threshold is a speed necessary to develop a gas film in the gas bearing supporting the rotor without the sliding contact of bearing components.

6. The electric motor apparatus of claim 4 wherein the electric motor is a combined winding motor and wherein the motor drive provides the predetermined upward force to the rotor during the first interval and during the second interval redistributes at least some of electrical energy used to produce the predetermined upward force into a torque force.

7. The electric motor apparatus of claim 1 wherein the electric motor is a two-pole motor adapted to provide a power of at least 200 kW.

8. The electric motor apparatus of claim 1 further including a compressor fan attached to the rotor shaft.

9. The electric motor apparatus of claim 1 wherein the bearing is one or more magnetic bearings together providing a maximum levitation component less than a weight of the rotor and shaft.

10. A method of operating an electric motor having a stator and a rotor rotatable on a shaft about an axis with respect to the stator, the electric motor including a winding set producing a magnetic field applying a force between the rotor and stator and providing at least one bearing supporting the shaft for rotation; the method comprising:
controlling electrical power to the winding set to apply a radial force to the rotor independent of torque force and independent of a contemporaneous measure radial rotor displacement with respect to the stator.

11. The method of claim 10 wherein the predetermined upward force is vertical.

12. The method of claim 10 wherein a magnitude of the predetermined upward force is substantially constant for a full revolution of the rotor.

13. The method of claim 10 wherein the bearing is a gas bearing and the predetermined upward force is applied to the rotor during a first interval defined by the rotational speed of the rotor being below a predetermined speed threshold and wherein the predetermined forces removed during a second interval defined by the rotor speed of the rotor is above the predetermined speed threshold.

14. The method of claim 13 wherein the bearing is a gas bearing and the predetermined speed threshold is a speed necessary to develop a gas film in the gas bearing supporting the rotor without the sliding contact of bearing components.

15. The method of claim 13 wherein the electric motor is a combined winding motor and wherein during the second interval at least some electrical energy used to produce the predetermined upward force is instead applied as a torque force.

16. The method of claim 10 wherein the electric motor is a two-pole motor adapted to provide a power of at least 200 kW.

17. The method of claim 10 further including a compressor fan attached to the rotor shaft.

18. The method of claim 10 wherein the bearing is one or more magnetic bearings together providing a maximum levitation component less than a weight of the rotor and shaft.
